(19) United States
(12) Patent Application Publication
(10) Pub. No.: US 2008/0186428 A1
(43) Pub. Date: Aug. 7, 2008

(54) OPTICAL APPARATUS, IMAGE DISPLAY, AND LIQUID CRYSTAL DISPLAY

(75) Inventors: Michie SAKAMOTO, Ibaraki-shi (JP); Megumu NAGASAWA, Ibaraki-shi (JP); Akira OOTANI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/026,873

(22) Filed: Feb. 6, 2008

(30) Foreign Application Priority Data
Feb. 6, 2007 (JP) 2007-027302
Jul. 17, 2007 (JP) 2007-185427

(51) Int. Cl. F21V 9/16; F21V 9/14; G02F 1/1335

(52) U.S. Cl. 349/62; 362/84; 362/19

(57) ABSTRACT

An optical apparatus that prevents unevenness in color and brightness from occurring in an image display, and can improve the color purity of transmitted light and color reproducibility of the image display and is excellent in practical use. An optical apparatus that includes a light source device; a reflective layer; a color purity improving sheet; and a reflective polarizer. The color purity improving sheet includes a light-emitting layer which improves purity of a color in a target wavelength range by absorbing light in a specific wavelength range other than the target wavelength range and converts the absorbed light to emitted light in the target wavelength range. Light emitted from the light source device exits through the reflective polarizer to the outside. The color purity improving sheet is disposed between the reflective polarizer and the reflective layer. The light source device is disposed in a location between the color purity improving sheet and the reflective layer.

### CROSS-REFERENCE TO RELATED APPLICATIONS

This application claims priority from Japanese Patent Application Nos. 2007-027302 filed on Feb. 6, 2007 and 2007-185427 filed on Jul. 17, 2007. The entire contents of which are hereby incorporated by reference.

### BACKGROUND OF THE INVENTION

1. Field of the Invention

The present invention relates generally to optical apparatuses, image displays and liquid crystal displays.

2. Description of the Related Art

Recently, liquid crystal displays that control light emitted from a light source device such as a cold-cathode tube or a light-emitting diode (LED) using a liquid crystal panel to form images have been developed and put into practical use. In the above-mentioned liquid crystal display, a light guide plate is disposed to uniformly distribute light emitted from the light source device over the whole display surface. The light guide plate is disposed in parallel with the liquid crystal panel so as to allow them to be placed on top of each other, and on an optical path extending to the light source device. The light source device is disposed beside the light guide plate or on the opposite side to the liquid crystal panel of the light guide plate.

Furthermore, recently, in order to improve brightness of the screen of the liquid crystal display, a reflective polarizer may be disposed between the light guide plate and the liquid crystal panel. The reflective polarizer transmits light that has been polarized in a predetermined manner, and reflects light other than the transmitted light.

An example of conventional liquid crystal displays is shown in the sectional view in FIG. 18. As shown in FIG. 18, this liquid crystal display includes, as main components, a liquid crystal panel 94, a reflective polarizer 90, a light guide plate 91, a cold-cathode tube 92, and a reflective layer 93. The liquid crystal panel 94 is configured with a first polarizing plate 931 and a second polarizing plate 932 being disposed on both sides of the liquid crystal cell 95. The liquid crystal cell 95 has a liquid crystal layer 940 in the middle thereof. A first alignment film 951 and a second alignment film 952 are disposed on both sides of the liquid crystal layer 940, respectively. A first transparent electrode 961 and a second transparent electrode 962 are disposed on the outer sides of the first alignment film 951 and the second alignment film 952, respectively. Color filters 970 of, for example, R (red), G (green), and B (blue) arranged in a predetermined manner and black matrices 990 are disposed on the outer side of the first transparent electrode 961, with a protective film 980 being interposed therebetween. A first substrate 901 and a second substrate 902 are disposed on the outer sides of the color filters 970 and black matrices 990 and the second transparent electrode 962, respectively. In the liquid crystal panel 94, the first polarizing plate 931 side is a display side, and the second polarizing plate 932 side is a back side. The reflective polarizer 90 is disposed on the back side of the liquid crystal panel 94. The light guide plate 91 is disposed on the opposite side to the liquid crystal panel 94 side of the reflective polarizer 90 and in parallel so that it and the liquid crystal panel 94 are placed on top of each other. The cold-cathode tube 92 is disposed on the opposite side of the liquid crystal panel 94 side of the light guide plate 91. The reflective layer 93 is disposed on the opposite side of the liquid crystal panel 94 side of the cold-cathode tube 92.

In this liquid crystal display, light emitted by the cold-cathode tube 92 is adjusted with the light guide plate 91 so that a uniform in-plane brightness distribution is obtained, and then is emitted to the second polarizing plate 932 side. Furthermore, after the emitted light is controlled pixel by pixel in the liquid crystal layer 940, only light in a predetermined wavelength range (for example, each wavelength range of R, G, and B) is transmitted by the color filter 970. Thus a color display is obtained. Light polarized in a predetermined manner that is contained in light emitted from the light guide plate 91 is transmitted through the reflective polarizer 90 and then passes through the liquid crystal panel 94 to exit to the display side. On the other hand, light other than that polarized in the predetermined manner is reflected by the reflective polarizer 90, is reversed by the reflective layer 93, and then enters the reflective polarizer 90 again. The light reversed by the reflective layer 93 is transmitted this time through the reflective polarizer 90 and passes through the liquid crystal panel 94 to exit to the display side.

In the conventional liquid crystal display, however, colors between any two of R, G, and B (for example, yellow light in the wavelength range between the wavelength range of R and the wavelength range of G, and light in the wavelength range between the wavelength range of G and the wavelength range of B) other than R, G, and B are mixed in the emission spectrum of a cold cathode tube, and they are not filtered out sufficiently with color filters. As a result, there has been a problem in that the color reproducibility deteriorates in the display image quality.

An optical apparatus for a liquid crystal display has been proposed as a means for solving this problem. The optical apparatus contains a fluorescent material that absorbs yellow light (light in the wavelength range between the wavelength range of R and the wavelength range of G) with a wavelength of 575 to 605 nm and emits light of R with a wavelength of at least 610 nm, and this fluorescent material converts the yellow light contained in the emission spectrum of a light source into the light of R (see JP 2005-276586 A). For this optical apparatus, a method has been proposed in which a light guide plate or a light reflector contains the fluorescent material. Furthermore, for this optical apparatus, another method also has been proposed in which the fluorescent material is applied to the upper surface or end faces of the light guide plate or the surface of a light source.

However, in the method in which a light guide plate or a light reflector contains the fluorescent material, there is a problem in that the fluorescent material is present in some regions and absent in other regions in the light guide plate or the light reflector depending on the locations thereof, and thereby the wavelength distribution spectrum of the light emitted is not constant, which causes unevenness in color. Furthermore, in the method in which the fluorescent material is applied to, for example, the upper surface of the light guide plate, there is a problem in that in-plane unevenness in brightness occurs. Moreover, the optical apparatus lacks is not suitable for practical use as, for example, the configuration thereof becomes complicated.

### SUMMARY OF THE INVENTION

The present invention therefore is intended to provide an optical apparatus that while preventing unevenness in color and brightness from occurring in an image display, can improve the color purity of transmitted light, can improve color reproducibility of the image display, and is excellent in practical use.

In order to achieve the above-mentioned object, an optical apparatus of the present invention includes:

a light source device;

a reflective layer;

a color purity improving sheet; and

a reflective polarizer,

wherein the color purity improving sheet includes a light-emitting layer containing a light-emitting means for improving purity of a color in a target wavelength range by absorbing light in a specific wavelength range other than the target wavelength range and then converting its wavelength to emit light in the target wavelength range,

light emitted from the light source device exits through the reflective polarizer to the outside,

the color purity improving sheet is disposed between the reflective polarizer and the reflective layer, and

the light source device is disposed in at least one location selected from a location between the color purity improving sheet and the reflective layer, a location between the reflective polarizer and the color purity improving sheet, and a location on the opposite side to the color purity improving sheet side of the reflective layer.

An image display of the present invention includes:

an optical apparatus, and

a display panel,

wherein the display panel including a display layer and a color filter,

wherein the display panel and the optical apparatus being disposed so that the display layer is located between the color filter and the optical apparatus, and

wherein light emitted from the optical apparatus passes through the display layer and then enters the color filter,

wherein the optical apparatus is an optical apparatus of the present invention described above.

A liquid crystal display of the present invention includes:

an optical apparatus, and

a liquid crystal panel,

with the liquid crystal panel including a liquid crystal layer and a color filter,

with the liquid crystal panel and the optical apparatus being disposed so that the liquid crystal layer is located between the color filter and the optical apparatus, and

with light emitted from the optical apparatus passes through the liquid crystal layer and then enters the color filter,

wherein the optical apparatus is an optical apparatus of the present invention described above.

In the optical apparatus of the present invention, the light-emitting means is contained in a single sheet (a light-emitting layer). Accordingly, in the optical apparatus of the present invention, the light-emitting means can be distributed uniformly in a sheet (light-emitting layer). As a result, the optical apparatus of the present invention makes it possible to improve the color purity of transmitted light while preventing unevenness in color and brightness from occurring. In the optical apparatus of the present invention, a color purity improving sheet including the light-emitting layer is disposed between the reflective polarizer and the reflective layer. In this case, at least a part of the light transmitted through the color purity improving sheet is reflected by the reflective polarizer or the reflective layer and then enters the color purity improving sheet again. Thus, in the optical apparatus of the present invention, since there is light that enters the color purity improving sheet repeatedly, the light wavelength conversion efficiency improves and the color purity further improves. As a result, with the optical apparatus of the present invention, the color reproducibility of the image display also can be improved. Moreover, with the optical apparatus of the present invention, the color purity can be improved by, for example, merely disposing the optical apparatus in a liquid crystal display. Thus, it is excellent in practical use.

### BRIEF DESCRIPTION OF THE DRAWINGS

FIG. 1 is a diagram for explaining the positions where a light source device is disposed in an optical apparatus of the present invention.

FIG. 2 is a sectional view showing an example of the configuration of an optical apparatus of the present invention.

FIG. 3 is a sectional view showing another example of the configuration of the optical apparatus of the present invention.

FIG. 4 is a sectional view showing still another example of the configuration of the optical apparatus of the present invention.

FIG. 5 is a sectional view showing an example of the configuration of a liquid crystal display of the present invention.

FIG. 6 is a sectional view showing another example of the configuration of the liquid crystal display of the present invention.

FIG. 7 is a sectional view showing still another example of the configuration of the liquid crystal display of the present invention.

FIG. 8 is a graph showing an absorption spectrum in an example of the fluorescent materials to be used in the present invention.

FIG. 9 is a graph showing an absorption spectrum in another example of the fluorescent materials to be used in the present invention.

FIG. 10 is a graph showing an absorption spectrum in still another example of the fluorescent materials to be used in the present invention.

FIG. 11 is a graph showing the result of emission spectrum measurement in an example of the present invention.

FIG. 12 is a graph showing the result of emission spectrum measurement in another example of the present invention.

FIG. 13 is a graph showing the result of emission spectrum measurement in still another example of the present invention.

FIG. 14 is a graph showing the result of emission spectrum measurement in yet another example of the present invention.

FIG. 15 is a graph showing the result of emission spectrum measurement in a reference example of the present invention.

FIG. 16 is a graph showing the result of emission spectrum measurement in another reference example of the present invention.

FIG. 17 is a graph showing the result of emission spectrum measurement in still another reference example of the present invention.

FIG. 18 is a sectional view showing an example of the configuration of a conventional liquid crystal display.

### DETAILED DESCRIPTION OF THE INVENTION

In the present invention, “improvement in color purity” embraces, for example, conversion of yellow light, which is a color between R and G, into light of R or G, conversion of light of a color between G and B into light of G, and/or conversion of light of any of R, G, and B into light of a color other than R, G, and B.

In the optical apparatus of the present invention, it is preferable that the light source device be disposed between the color purity improving sheet and the reflective layer.

In the optical apparatus of the present invention, it is preferable that the light-emitting layer be formed of a matrix polymer and a fluorescent material.

In the optical apparatus of the present invention, examples of the fluorescent material include fluoresceins, rhodamines, coumarins, dansyls (dimethylaminonaphthalenesulfonic acids), 7-nitrobenzo-2-oxa-1,3-diazol (NBD) dyes, pyrene, perylene, phycobiliprotein, cyanine pigment, anthraquinone, thioindigo, and benzopyran fluorescent materials. One of the fluorescent materials can be used individually or two or more of them can be used in combination.

In the optical apparatus of the present invention, it is preferable that the fluorescent material be a perylene fluorescent material.

In the optical apparatus of the present invention, it is preferable that the perylene fluorescent material be represented by the following structural formula (1):

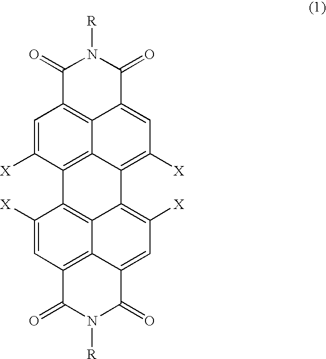

where four Xs each are a halogen group or an alkoxy group, the respective Xs can be identical to or different from one another, and two Rs each are an aryl group or an alkyl group, the respective Rs can be identical to or different from each other.

In the optical apparatus of the present invention, it is preferable that the fluorescent material be a thioindigo fluorescent material.

In the optical apparatus of the present invention, it is preferable that the thioindigo fluorescent material be represented by the following structural formula (2):

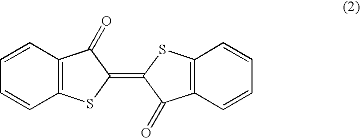

In the optical apparatus of the present invention, it is preferable that the fluorescent material be an anthraquinone fluorescent material.

In the optical apparatus of the present invention, it is preferable that the anthraquinone fluorescent material be represented by the following structural formula (3):

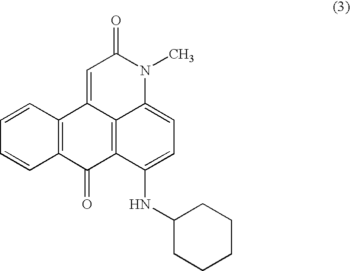

In the optical apparatus of the present invention, examples of the matrix polymer include polymethylmethacrylate, polyacrylic resin, polycarbonate resin, polynorbornene resin, polyvinyl alcohol resin, and cellulose resin. One of the matrix polymers may be used individually or two or more of them may be used in combination.

In the optical apparatus of the present invention, it is preferable that the matrix polymer be polymethylmethacrylate.

In the optical apparatus of the present invention, the specific wavelength range of light that is absorbed by the light-emitting layer is not particularly limited, and it can be, for example, in the range of 560 to 610 nm. The target wavelength range of light emitted by the light-emitting layer is not particularly limited, and it can be, for example, in the range of 610 to 700 nm.

Preferably, the optical apparatus of the present invention further includes a light guide plate, and light emitted from the light source device exits to the reflective polarizer side through the light guide plate.

Next, the optical apparatus of the present invention is described using examples.

As described above, the optical apparatus of the present invention includes a light source device, a reflective layer, a color purity improving sheet, and a reflective polarizer. In the optical apparatus of the present invention, for example, as shown in FIG. 1, the color purity improving sheet 11 is disposed between the reflective polarizer 10 and the reflective layer 13. In the optical apparatus of the present invention, for example, as shown in FIG. 1, the light source device is disposed in at least one location selected from a location (position X shown in FIG. 1) between the color purity improving sheet 11 and the reflective layer 13, a location (position Y shown in FIG. 1) between the reflective polarizer 10 and the color purity improving sheet 11, and a location (position Z shown in FIG. 1) on the opposite side to the color purity improving sheet 11 side of the reflective layer 13.

The reflective polarizer to be employed herein can be, for example, an arbitrary suitable film that separates linearly polarized light from natural light or polarized light. Examples of the film that separates the linearly polarized light include a film that transmits one of linearly polarized lights orthogonal in the axis direction and reflects the other. Specific examples of such a reflective polarizer include a grid polarizer, a multilayer thin film laminate including at least two layers made of at least two types of materials having a difference in refractive index from each other, a vapor-deposited multilayer thin film having different refractive indices, which is used, for example, for a beam splitter, and one obtained by stretching a resin laminate including at least two layers made of at least two types of resins having a difference in refractive index from each other. More specifically, the reflective polarizer to be used herein can be, for example, one obtained by uniaxially stretching a multilayer laminate formed by alternately laminating a resin that exhibits less phase difference (for example, norbornene resin such as one of a series of “ARTON” (trade name) manufactured by JSR Corporation) and a material that exhibits a phase difference through stretching (for example, polyethylene naphthalate, polyethylene terephthalate (PET), or polycarbonate) or acrylic resin (for example, polymethylmethacrylate). A commercially available reflective polarizer is, for example, as “DBEF” (trade name) manufactured by Sumitomo 3M Limited. The thickness of the reflective polarizer is not particularly limited and is, for example, in the range of 50 to 200 μm.

The color purity improving sheet has a light-emitting layer including the light-emitting means that improves the purity of the color in the target wavelength range by absorbing light (light of an unnecessary color) in a specific wavelength range other than the target wavelength range, converting its wavelength, and then emitting light (light of a required color) in the target wavelength range.

It is preferable that the light-emitting means contain a fluorescent material. Examples of the fluorescent material are as described above.

Specific examples of the fluorescent material include “Lumogen F Red 305 (perylene)” (trade name) manufactured by BASF AG, “Plast Red 8355 and 8365 (anthraquinone), Plast Red D-54 (thioindigo), Plast Red DR-426 and DR-427 (benzopyran)” (trade names) manufactured by Arimoto Chemical Co., Ltd., and “NK-1533 (carbocyanine dye)” (trade name) manufactured by Hayashibara Biochemical Labs., Inc. These fluorescent materials absorb yellow light (with a wavelength of 560 to 610 nm), which is a color between R and G, and emit light (with a wavelength of 610 to 650 nm) of R.

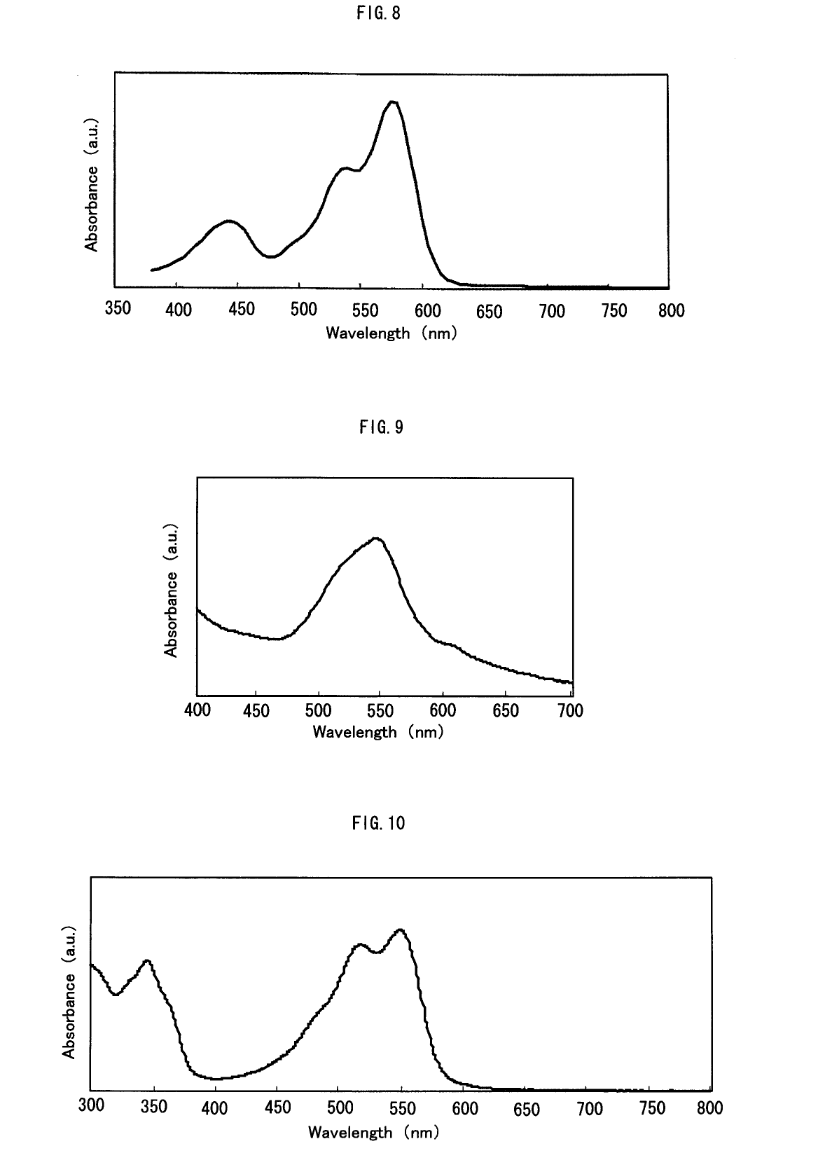

As described above, it is preferable that the perylene fluorescent material be represented by the structural formula (1). The absorption spectrum of the fluorescent material represented by the structural formula (1) is shown in the graph in FIG. 8. As shown in FIG. 8, this fluorescent material has a maximum absorption wavelength around 585 nm.

As described above, it is preferable that the thioindigo fluorescent material be represented by the structural formula (2). The absorption spectrum of the fluorescent material represented by the structural formula (2) is shown in the graph in FIG. 9. As shown in FIG. 9, this fluorescent material has a maximum absorption wavelength around 550 nm.

As described above, it is preferable that the anthraquinone fluorescent material be represented by the structural formula (3). The absorption spectrum of the fluorescent material represented by the structural formula (3) is shown in the graph in FIG. 10. As shown in FIG. 10, this fluorescent material has a maximum absorption wavelength around 550 nm.

As described above, it is preferable that the light-emitting layer be formed of a matrix polymer and a fluorescent material. The light-emitting layer can be produced by, for example, mixing the fluorescent material with a matrix polymer capable of being formed into a film and then forming the mixture into a film. Preferably, the matrix polymer has high transparency and examples thereof include polyacrylic resins such as polymethylmethacrylate, polyethyl acrylate, and polybutyl acrylate; polycarbonate resins such as polyoxycarbonyloxyhexamethylene, and polyoxycarbonyloxy-1,4-isopropylidene-1,4-phenylene, polynorbornene resins, polyvinyl alcohol resins such as polyvinyl formal, polyvinyl acetal, and polyvinyl butyral; and cellulose resins such as methylcellulose, ethylcellulose, and derivatives thereof. Among them, polymethylmethacrylate is preferred. One of the matrix polymers may be used individually or two or more of them may be used in combination.

The abovementioned term “polynorbornene resins” denotes (co)polymers obtained with a norbornene monomer having a norbornene ring used for a part or all of a starting material (a monomer). The term “(co)polymers” denotes homopolymers or copolymers.

Next, the method of forming the light-emitting layer is described using an example but is not limited to the example.

First, the matrix polymer is dissolved in a solvent and thereby a polymer solution is prepared. Examples of the solvent to be used herein include toluene, methyl ethyl ketone, cyclohexanone, ethyl acetate, ethanol, tetrahydrofuran, cyclopentanone, and water.

Next, the fluorescent material is added to and dissolved in the polymer solution. The amount of the fluorescent material to be added can be determined suitably according to the type of the fluorescent material. With respect to 100 parts by weight of the matrix polymer, it can be, for example, in the range of 0.01 to 80 parts by weight, preferably in the range of 0.1 to 50 parts by weight, and more preferably in the range of 0.1 to 30 parts by weight.

Subsequently, the polymer solution to which the fluorescent material has been added is applied onto a substrate to form a coating film, which is then dried by heating. Thus, a film is formed.

Next, the film is separated from the substrate and thereby the light-emitting layer can be obtained. The thickness of the light-emitting layer is not particularly limited. It is, for example, in the range of 0.1 to 1000 μm, preferably in the range of 1 to 200 μm, and more preferably in the range of 2 to 50 μm.

The color purity improving sheet may have any structure as long as it includes the light-emitting layer. For example, the color purity improving sheet may be composed of the light-emitting layer alone. Furthermore, the color purity improving sheet may include something other than the light-emitting layer.

The light source device is not particularly limited. Examples thereof include a cold-cathode tube and a light-emitting diode (LED).

The type and the material of the reflective layer are not particularly limited, for example. Preferably, the reflective layer is formed of a material with a high optical reflectance. Examples of the material include a plastic film or sheet that has a silver sputtered layer, a silver deposited layer, or a high optical reflectance ink layer. The thickness of the reflective layer is not particularly limited and is, for example, in the range of 100 to 500 μm.

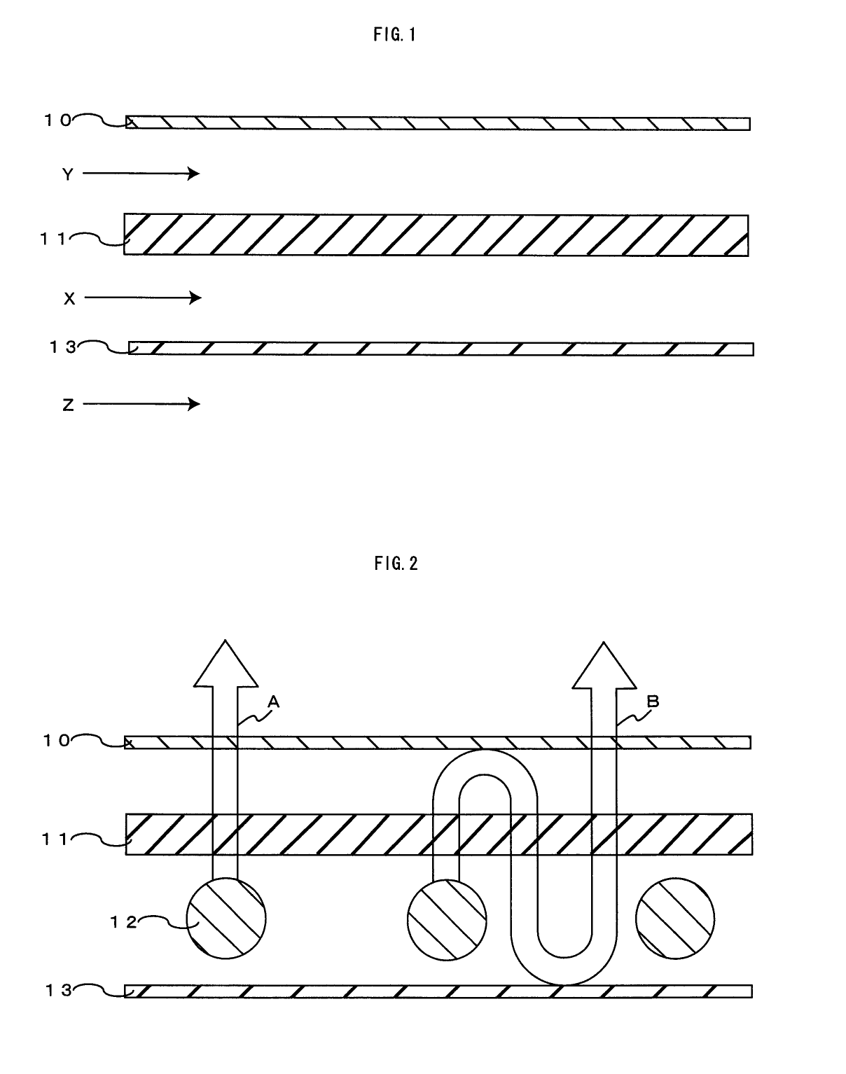

An example of the configuration of an optical apparatus of the present invention is shown in the sectional view in FIG. 2. In FIG. 2, parts that are identical to those shown in FIG. 1 are indicated with identical numerals. In the optical apparatus of this example, the light source device 12 is disposed in a location (position X shown in FIG. 1) between the color purity improving sheet 11 and the reflective layer 13.

Improvement in color purity of the optical apparatus of the present invention is described using the optical apparatus shown in FIG. 2 as an example. The color purity is improved, for example, as follows. For example, the light source device 12 to be used herein has high emission peaks of B around 435 nm, G around 545 nm, and R around 610 nm. In the optical apparatus of this example, suppose only emission lights of G and R are used and emission yellow light (around 585 nm), which is a color between G and R, is unnecessary. In this case, the light-emitting layer of the color purity improving sheet 11 contains a fluorescent material that, for example, has a maximum absorption peak wavelength of around 585 nm and emits light with a wavelength of at least 610 nm. Light emitted from the light source device 12 enters the color purity improving sheet 11 as shown with arrows A and B. A part of the yellow light contained in light that has entered the color purity improving sheet 11 is absorbed by the fluorescent material and R light with a wavelength of at least 610 nm is emitted. Light polarized in a predetermined manner that is contained in the light transmitted through the color purity improving sheet 11 passes through the reflective polarizer 10 to exit to the outside as shown with arrow A. On the other hand, light other than that polarized in the predetermined manner is reflected by the reflective polarizer 10 and enters the color purity improving sheet 11 again as shown with arrow B. A part of the light that has entered the color purity improving sheet 11 again is transmitted to the reflective layer 13 side. Light transmitted to the reflective layer 13 side is reflected partially by the reflective layer 13 and enters the color purity improving sheet 11 once again. Thus, the light transmitted through the color purity improving sheet 11 is reflected partially by the reflective polarizer 10 or the reflective layer 13 and enters the color purity improving sheet 11 repeatedly, so that the color purity of light further is improved. Light partially reflected by the reflective layer 13 passes through the reflective polarizer 10 this time to exit to the outside. The arrows A and B described above schematically illustrate the optical paths in the optical apparatus of this example. However, the optical paths in the optical apparatus of this example are not limited to those shown with the arrows A and B described above. For example, light emitted from the light source device 12 to the reflective layer 13 side and light emitted from the color purity improving sheet 11 to the reflective layer 13 side through light emission of the fluorescent material contained in the color purity improving sheet 11 are reflected partially by the reflective layer 13 and then enter the color purity improving sheet 11.

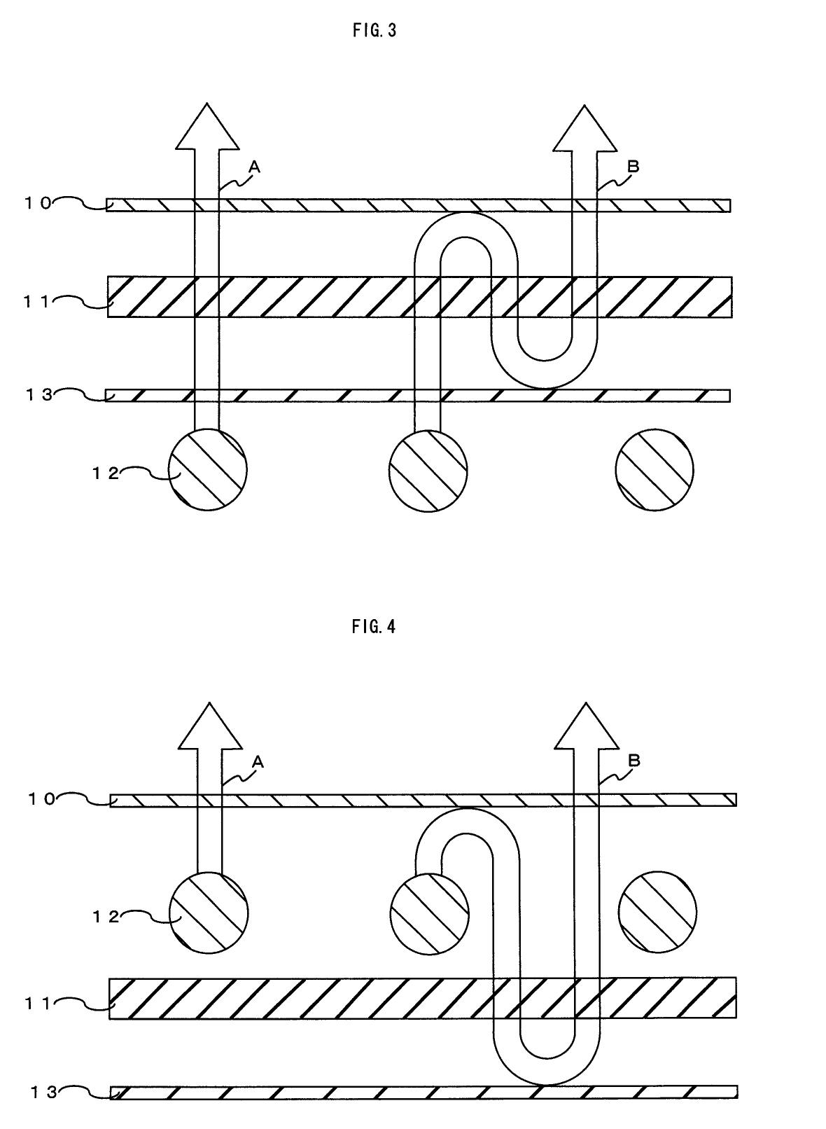

FIG. 3 shows another example of the configuration of the optical apparatus according to the present invention. In FIG. 3, identical parts as those shown in FIGS. 1 and 2 are indicated with identical numerals. In the optical apparatus of this example, a light source device 12 is disposed in a location (position Z shown in FIG. 1) on the opposite side to the color purity improving sheet 11 side of the reflective layer 13. Even with such a configuration, a similar color purity improving effect to that obtained in the optical apparatus shown in FIG. 2 can be obtained as shown with arrow A and arrow B. In this optical apparatus, it is preferable that the reflective layer 13 have optical reflectance provided only for the surface located on the color purity improving sheet 11 side.

FIG. 4 shows still another example of the configuration of the optical apparatus according to the present invention. In FIG. 4, identical parts as those shown in FIGS. 1 to 3 are indicated with identical numerals. In the optical apparatus of this example, a light source device 12 is disposed in a location (position Y shown in FIG. 1) between the reflective polarizer 10 and the color purity improving sheet 11. In this optical apparatus, light shown with arrow A passes through the reflective polarizer 10 without entering the color purity improving sheet 11 to exit to the outside. However, light shown with arrow B enters the color purity improving sheet 11 twice. Accordingly, the color purity of light is improved even with such a configuration being employed, as compared to conventional optical apparatuses having no color purity improving sheets.

As described above, the optical apparatus of the present invention further includes a light guide plate. In the optical apparatus of the present invention, light emitted from the light source device may be allowed to exit to the reflective polarizer side through the light guide plate.

The optical apparatus of the present invention further may include another component, examples of which include a diffuser plate and a prism sheet. It can be disposed, for example, between any adjacent components of the respective components (for example, between the reflective polarizer and the color purity improving sheet or between the color purity improving sheet and the light guide plate).

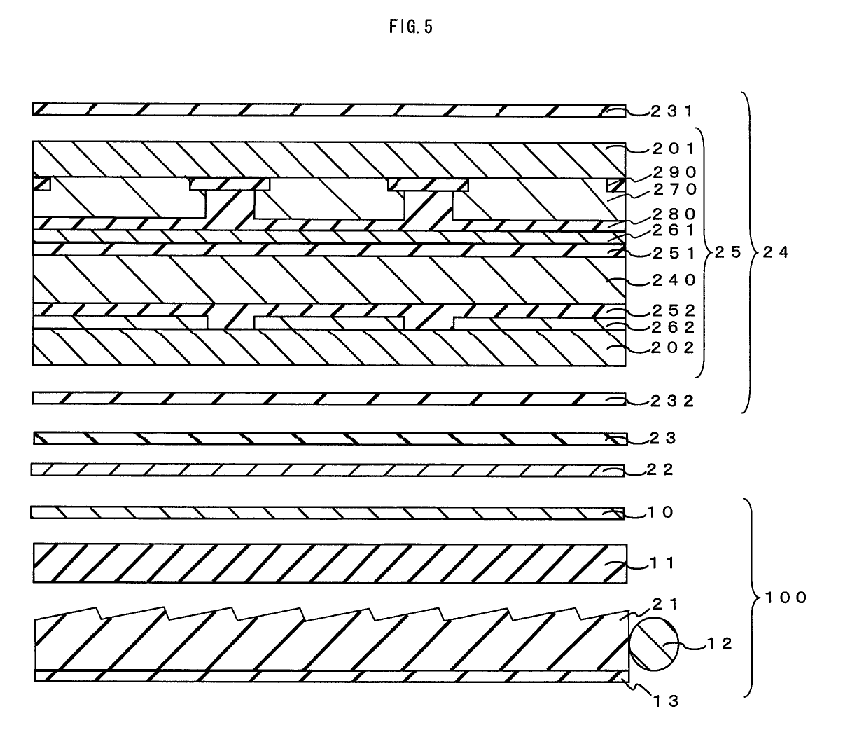

The optical apparatus of the present invention can be used suitably for various image displays such as liquid crystal displays (LCDs) and EL displays (ELDs). The optical apparatus of the present invention may be formed monolithically with an image display or may be configured as a separate apparatus. An example of the configuration of a liquid crystal display of the present invention is shown in the sectional view in FIG. 5. In FIG. 5, identical parts as those shown in FIGS. 1 to 4 are indicated with identical numerals. In FIG. 5, in order to make it clearly understandable, for example, the sizes and ratios of the respective components are different from those actually used. As shown in FIG. 5, this liquid crystal display includes a liquid crystal panel 24, a diffuser plate 23, a prism sheet 22, and an optical apparatus 100 of the present invention as main components. The liquid crystal panel 24 is configured to have a first polarizing plate 231 and a second polarizing plate 232 that are disposed on both sides of a liquid crystal cell 25, respectively. The liquid crystal cell 25 is provided with a liquid crystal layer 240 in the middle thereof. A first alignment film 251 and a second alignment film 252 are disposed on both sides of the liquid crystal layer 240, respectively. A first transparent electrode 261 and a second transparent electrode 262 are disposed on the outer sides of the first alignment film 251 and the second alignment film 252, respectively. Color filters 270 of, for example, R, G, and B arranged in a predetermined manner and black matrices 290 are disposed on the outer side of the first transparent electrode 261, with a protective film 280 being interposed therebetween. A first substrate 201 and a second substrate 202 are disposed on the outer sides of the color filters 270 and black matrices 290 and the second transparent electrode 262, respectively. In the liquid crystal panel 24, the first polarizing plate 231 side is a display side, and the second polarizing plate 232 side is a back side. The diffuser plate 23 is disposed on the back side of the liquid crystal panel 24. The prism sheet 22 is disposed on the opposite side to the liquid crystal panel 24 side of the diffuser plate 23. The optical apparatus 100 of the present invention is disposed on the opposite side to the liquid crystal panel 24 side of the prism sheet 22, with a reflective polarizer 10 being located on the liquid crystal panel 24 side. In the optical apparatus 100 of the present invention, the light guide plate 21 and the light source device 12 are disposed in a location between the color purity improving sheet 11 and the reflective layer 13. The light source device 12 is disposed beside the light guide plate 21 (the right side in FIG. 5). With the liquid crystal display (optical apparatus) of this example, the case is illustrated where a side light type is employed in which the light source device 12 is disposed beside the light guide plate 21. However, the present invention is not limited thereto. The liquid crystal display (optical apparatus) of the present invention may be of a direct type in which, for example, the light source device 12 is disposed directly under the liquid crystal panel 24 via the light guide plate 21.

Another example of the configuration of the liquid crystal display according to the present invention is shown in the sectional view in FIG. 6. In FIG. 6, identical parts as those shown in FIG. 5 are indicated with identical numerals. In FIG. 6, in order to make it clearly understandable, for example, the sizes and ratios of the respective components are different from those actually used. As shown in FIG. 6, this liquid crystal display is identical to the liquid crystal display shown in FIG. 5 except that the positions where the components are disposed are partially different. In this liquid crystal display, an optical apparatus 101 of the present invention also includes the prism sheet 22 and the diffuser plate 23. In the optical apparatus 101 of the present invention, the prism sheet 22 is disposed on the opposite side to the reflective polarizer 10 side of the color purity improving sheet 11. Furthermore, in the optical apparatus 101 of the present invention, the diffuser plate 23 is disposed on the opposite side to the color purity improving sheet 11 side of the prism sheet 22. The configuration other than these components is identical to that of the liquid crystal display shown in FIG. 5.

In the liquid crystal display (optical apparatus 101) shown in FIG. 6, the location where the color purity improving sheet 11 is to be mounted can be anywhere, so long as it is between the reflective polarizer 10 and the reflective layer 13. The location where the color purity improving sheet 11 is to be mounted may be, for example, between the prism sheet 22 and the diffuser plate 23. Furthermore, the location where the color purity improving sheet 11 is to be mounted may be, for example, between the diffuser plate 23 and the light guide plate 21.

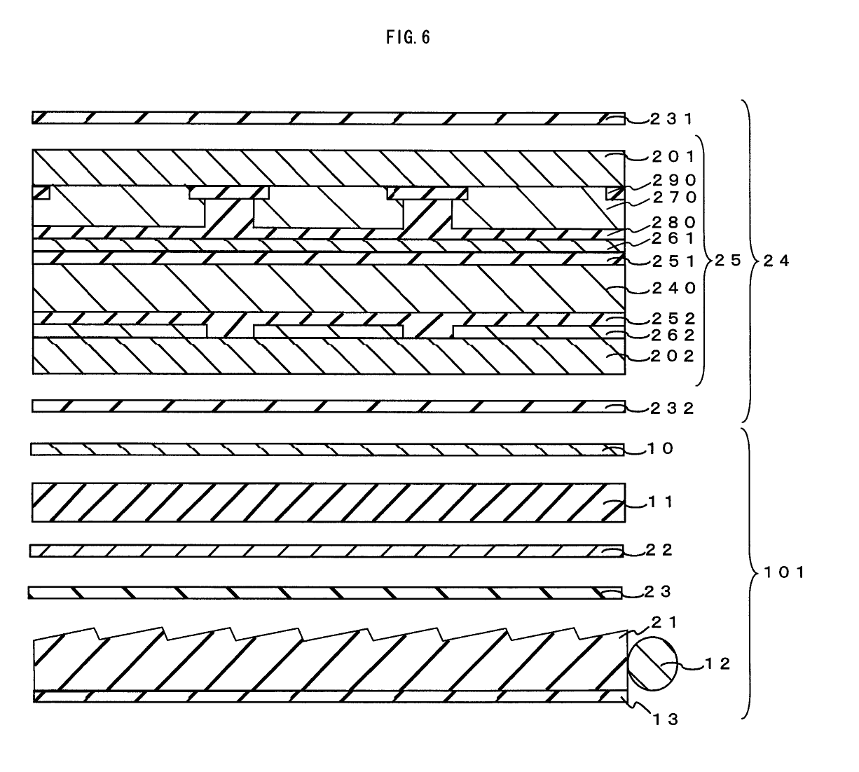

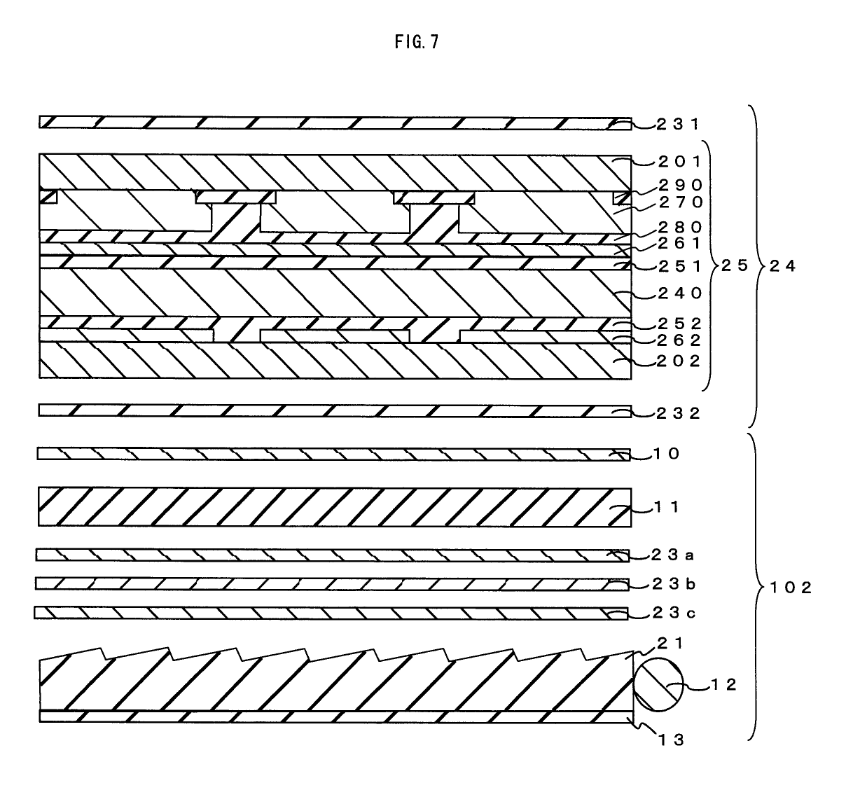

Still another example of the configuration of the liquid crystal display according to the present invention is shown in the sectional view in FIG. 7. In FIG. 7, identical parts as those shown in FIGS. 5 and 6 are indicated with identical numerals. In FIG. 7, in order to make it clearly understandable, for example, the sizes and ratios of the respective components are different from those actually used. As shown in FIG. 7, this liquid crystal display is identical to the liquid crystal display shown in FIG. 6 except that the components of the optical apparatus of the present invention are partially different. In this liquid crystal display, an optical apparatus 102 of the present invention includes a first diffuser plate 23a, a second diffuser plate 23b, and a third diffuser plate 23c instead of the prism sheet 22 and the diffuser plate 23 of the optical apparatus 101 of the present invention shown in FIG. 6. In the optical apparatus 102 of the present invention, the first diffuser plate 23a is disposed on the opposite side to the reflective polarizer 10 side of the color purity improving sheet 11. In the optical apparatus 102 of the present invention, the second diffuser plate 23b is disposed on the opposite side to the color purity improving sheet 11 side of the first diffuser plate 23a. Furthermore, in the optical apparatus 102 of the present invention, the third diffuser plate 23c is disposed on the opposite side to the first diffuser plate 23a side of the second diffuser plate 23b.

In the liquid crystal display (optical apparatus 102) shown in FIG. 7, the location where the color purity improving sheet 11 is to be mounted can be anywhere, so long as it is between the reflective polarizer 10 and the reflective layer 13. The location where the color purity improving sheet 11 is to be mounted may be, for example, between the second diffuser plate 23b and the third diffuser plate 23c. Moreover, the location where the color purity improving sheet 11 is to be mounted may be, for example, between the third diffuser plate 23c and the light guide plate 21.

### EXAMPLES

Next, examples of the present invention are described. The present invention is neither limited nor restricted by the following examples by any means. In the respective examples, a light of R alone was necessary and lights other than that were unnecessary.

### Example 1

### <Production of Color Purity Improving Sheet>

A fluorescent material (“Lumogen F Red 305” (trade name), manufactured by BASF Corporation) represented by the aforementioned structural formula (1) was added to and dissolved in 30% by weight toluene solution of polymethyl methacrylate so as to be 0.19% by weight with respect to polymethyl methacrylate. This solution was applied onto a PET film base material, which had been subjected to a treatment for separation, with an applicator to form a coating film. This was dried at 80° C. for 30 minutes. Thus, a film was obtained. After drying, the film was separated from the PET film base material and thereby a color purity improving sheet composed of a 30-μm thick light-emitting layer alone was obtained.

### <Mounting Onto Liquid Crystal Display>

The color purity improving sheet 11 was mounted onto a liquid crystal display including an optical apparatus 100 in the manner as shown in FIG. 5, and then the emission spectrum thereof was measured with a spectrophotometer (“Multi Channel Photo Detector, MCPD-3000” (trade name), manufactured by Otsuka Electronics Co., Ltd.). In this case, the light-receiving unit of the spectrophotometer was brought into close contact with the display side (the upper side in FIG. 5) of the liquid crystal display.

### Example 2

The emission spectrum was measured in the same manner as in Example 1 except that the color purity improving sheet 11 was mounted onto a liquid crystal display including an optical apparatus 101 in the manner as shown in FIG. 6.

### Example 3

The emission spectrum was measured in the same manner as in Example 2 except that the color purity improving sheet 11 was mounted between the prism sheet 22 and the diffuser plate 23.

### Example 4

The emission spectrum was measured in the same manner as in Example 2 except that the color purity improving sheet 11 was mounted between the diffuser plate 23 and the light guide plate 21.

### Example 5

### <Production of Color Purity Improving Sheet>

A fluorescent material (“Plast Red D-54” (trade name), manufactured by Arimoto Chemical Co., Ltd.) represented by the aforementioned structural formula (2) was added to and dissolved in 30% by weight toluene solution of polymethyl methacrylate so as to be 0.21% by weight with respect to polymethyl methacrylate. This solution was applied onto a PET film base material, which had been subjected to a treatment for separation, with an applicator to form a coating film. This was dried at 80° C. for 30 minutes. Thus, a film was obtained. After drying, the film was separated from the PET film base material and thereby a color purity improving sheet composed of a 63-μm thick light-emitting layer alone was obtained.

### <Mounting Onto Liquid Crystal Display>

The emission spectrum was measured in the same manner as in Example 1 except that the color purity improving sheet 11 was mounted onto the liquid crystal display including an optical apparatus 102 in the manner as shown in FIG. 7.

### Example 6

The emission spectrum was measured in the same manner as in Example 5 except that the color purity improving sheet 11 was mounted between the second diffuser plate 23b and the third diffuser plate 23c.

### Example 7

The emission spectrum was measured in the same manner as in Example 5 except that the color purity improving sheet 11 was mounted between the third diffuser plate 23c and the light guide plate 21.

### Example 8

### <Production of Color Purity Improving Sheet>

A fluorescent material (“Plast Red 8355” (trade name), manufactured by Arimoto Chemical Co., Ltd.) represented by the aforementioned structural formula (3) was added to and dissolved in 30% by weight toluene solution of polymethyl methacrylate so as to be 0.19% by weight with respect to polymethyl methacrylate. This solution was applied onto a PET film base material, which had been subjected to a treatment for separation, with an applicator to form a coating film. This was dried at 80° C. for 30 minutes. Thus, a film was obtained. After drying, the film was separated from the PET film base material and thereby a color purity improving sheet composed of a 31-μm thick light-emitting layer alone was obtained.

### <Mounting Onto Liquid Crystal Display>

The emission spectrum was measured in the same manner as in Example 1 except that the color purity improving sheet 11 was mounted onto the liquid crystal display including an optical apparatus 102 in the manner as shown in FIG. 7.

### Example 9

The emission spectrum was measured in the same manner as in Example 8 except that the color purity improving sheet 11 was mounted between the second diffuser plate 23b and the third diffuser plate 23c.

### Example 10

The emission spectrum was measured in the same manner as in Example 8 except that the color purity improving sheet 11 was mounted between the third diffuser plate 23c and the light guide plate 21.

### Reference Example 1

The emission spectrum was measured in the same manner as in Example 1 except that the color purity improving sheet 11 was mounted on the first polarizing plate 231.

### Reference Example 2

The emission spectrum was measured in the same manner as in Example 1 except that the color purity improving sheet 11 was mounted between the second polarizing plate 232 and the diffuser plate 23.

Reference Example 3

The emission spectrum was measured in the same manner as in Example 2 except that the color purity improving sheet 11 was mounted between the second polarizing plate 232 and the reflective polarizer 10.

### Reference Example 4

The emission spectrum was measured in the same manner as in Example 5 except that the color purity improving sheet 11 was mounted between the second polarizing plate 232 and the reflective polarizer 10.

### Reference Example 5

The emission spectrum was measured in the same manner as in Example 8 except that the color purity improving sheet 11 was mounted between the second polarizing plate 232 and the reflective polarizer 10.

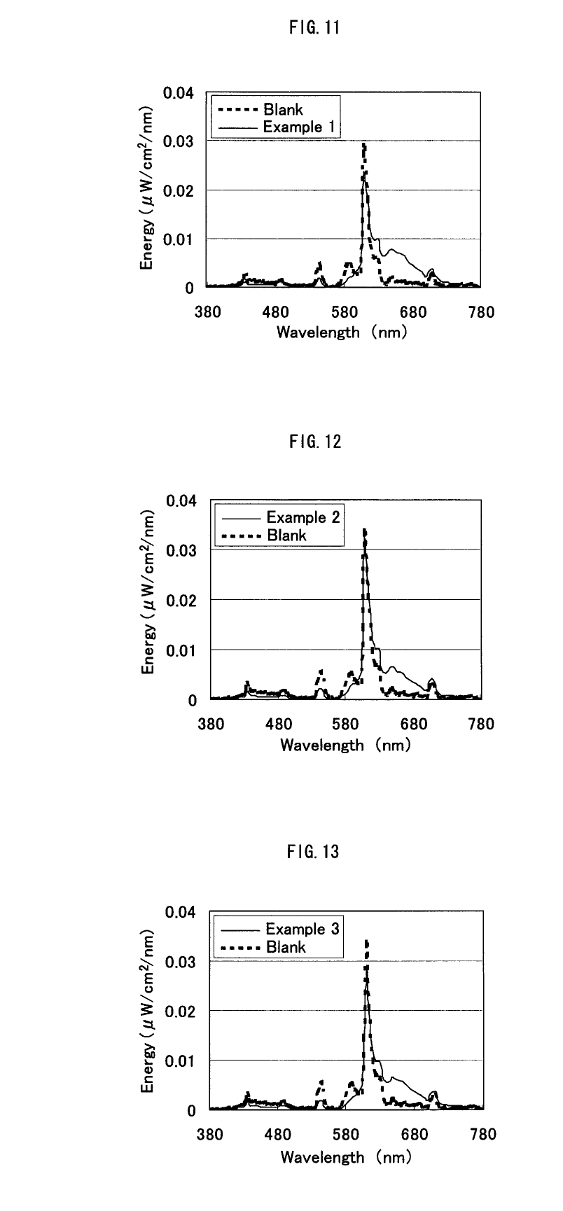

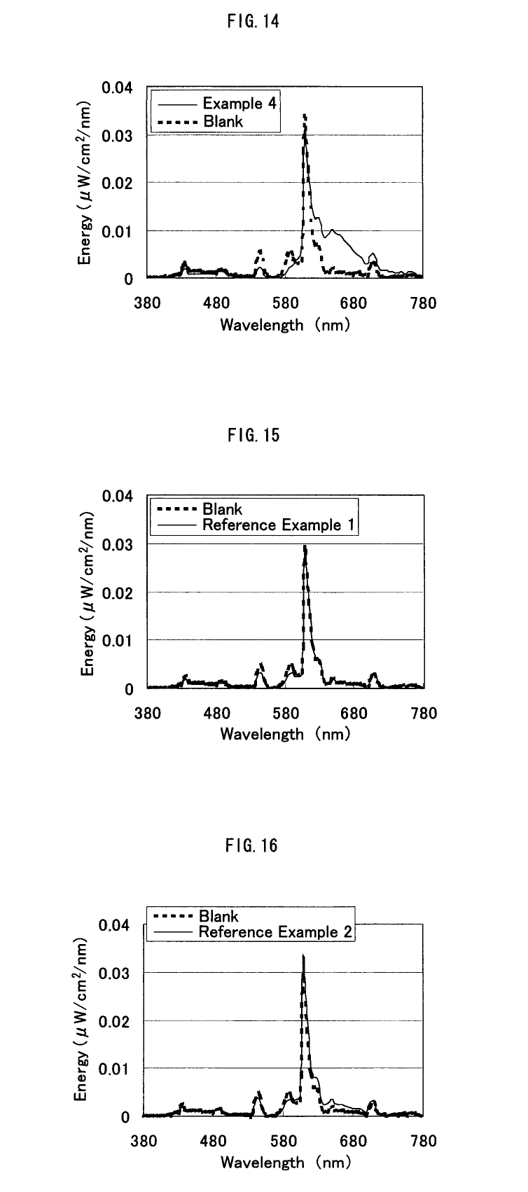

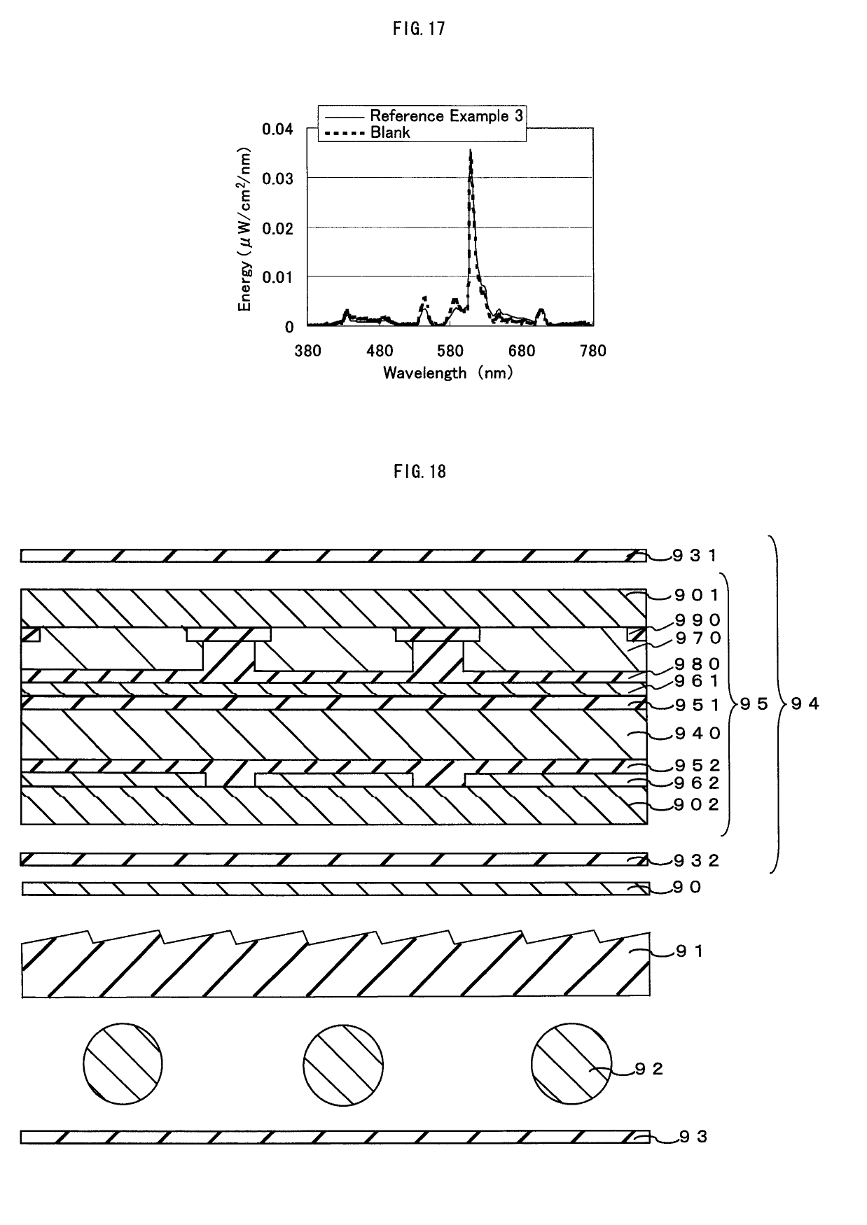

Results of emission spectrum measurement in Examples 1 to 4 and Reference Examples 1 to 3 are indicated in FIGS. 11 to 17 together with the result of emission spectrum measurement carried out to a blank with no color purity improving sheet mounted on the liquid crystal display. Table 1 below shows the spectral intensity ratios at 580 nm (yellow) and 650 nm (R), which were obtained when the blank was considered as 1, in all Examples and Reference Examples.

TABLE 1

| | | Emission | Emission |
|---|---|---|---|
| | | Intensity | Intensity |
| | Fluorescent Material | at 580 nm | at 650 nm |
| Example 1 | Structural Formula (1) | 0.29 | 4.4 |
| Example 2 | Structural Formula (1) | 0.45 | 3.7 |
| Example 3 | Structural Formula (1) | 0.32 | 3.3 |
| Example 4 | Structural Formula (1) | 0.30 | 5.0 |
| Example 5 | Structural Formula (2) | 0.60 | 1.5 |
| Example 6 | Structural Formula (2) | 0.54 | 1.5 |
| Example 7 | Structural Formula (2) | 0.54 | 1.4 |
| Example 8 | Structural Formula (3) | 0.81 | 1.4 |
| Example 9 | Structural Formula (3) | 0.69 | 1.4 |
| Example 10 | Structural Formula (3) | 0.67 | 1.3 |
| Reference Example 1 | Structural Formula (1) | 0.61 | 1.1 |
| Reference Example 2 | Structural Formula (1) | 0.59 | 1.3 |
| Reference Example 3 | Structural Formula (1) | 0.67 | 1.8 |
| Reference Example 4 | Structural Formula (2) | 0.79 | 1.2 |
| Reference Example 5 | Structural Formula (3) | 0.88 | 1.1 |

As can be understood from Table 1 above and FIGS. 11 to 17, emission of unnecessary yellow at 580 nm was reduced by about 50 to 60% and emission of necessary R at 650 nm was increased by about twice in Examples 1 to 4, as compared with Reference Examples 1 to 3 in which the same fluorescent material was used. As can be understood from Table 1 above, emission of unnecessary yellow at 580 nm was reduced by about 10 to 20% and emission of necessary R at 650 nm was increased by about 10 to 20% in Examples 5 to 7, as compared with Reference Example 4 in which the same fluorescent material was used. Similarly, as can be understood from Table 1 above, emission of unnecessary yellow at 580 nm was reduced by about 10 to 20% and emission of necessary R at 650 nm was increased by about 10 to 20% in Examples 8 to 10, as compared with Reference Example 5 in which the same fluorescent material was used.

As described above, while preventing unevenness in color and brightness from occurring in an image display, the optical apparatus of the present invention can improve the color purity of transmitted light and can improve color reproducibility of the image display. The optical apparatus of the present invention and an image display including the same can be used, for example, for office equipment such as a desktop PC, a notebook PC, and a copy machine, portable devices such as a cell phone, a watch, a digital camera, a personal digital assistant (PDA), and a handheld game machine, home electric appliances such as a video camera, a television set, and a microwave oven, vehicle equipment such as a back monitor, a monitor for car-navigation systems, and a car audio, display equipment such as an information monitor for stores, security equipment such as a surveillance monitor, and care and medical equipment such as a monitor for care and a monitor for medical use. However, the uses thereof are not limited and they are applicable to a wide field.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical apparatus, comprising:
a light source device;
a reflective layer;
a color purity improving sheet; and
a reflective polarizer,
wherein the color purity improving sheet includes a light-emitting layer which improves purity of a color in a target wavelength range by absorbing light in a specific wavelength range other than the target wavelength range and converting the absorbed light to emitted light in the target wavelength range,
light emitted from the light source device exits through the reflective polarizer to an outside,
the color purity improving sheet is disposed between the reflective polarizer and the reflective layer, and
the light source device is disposed in at least one location selected from a location between the color purity improving sheet and the reflective layer, a location between the reflective polarizer and the color purity improving sheet, and a location on an opposite side to a side of the color purity improving sheet of the reflective layer.

2. The optical apparatus according to claim 1, wherein the light source device is disposed in the location between the color purity improving sheet and the reflective layer.

3. The optical apparatus according to claim 1, wherein the light-emitting layer is formed of a matrix polymer and a fluorescent material.

4. The optical apparatus according to claim 3, wherein the fluorescent material is at least one selected from the group consisting of fluoresceins, rhodamines, coumarins, dansyls, 7-nitrobenzo-2-oxa-1,3-diazole pigments, pyrene, perylenes, phycobiliproteins, cyanine pigments, anthraquinones, thioindigos, and benzopyrans.

5. The optical apparatus according to claim 4, wherein the fluorescent material is a perylene fluorescent material.

6. The optical apparatus according to claim 5, wherein the perylene fluorescent material is represented by the following structural formula (1): 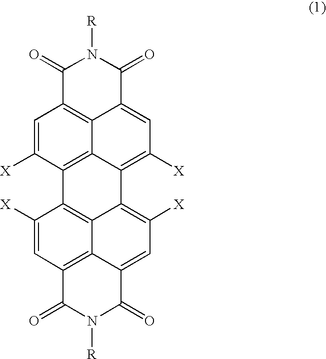
where four Xs each are a halogen group or an alkoxy group, the respective Xs can be identical to or different from one another, and two Rs each are an aryl group or an alkyl group, the respective Rs can be identical to or different from each other.

7. The optical apparatus according to claim 4, wherein the fluorescent material is a thioindigo fluorescent material.

8. The optical apparatus according to claim 7, wherein the thioindigoes fluorescent material is represented by the following structural formula (2):

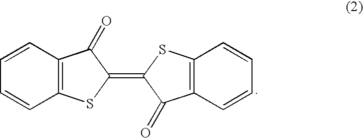

9. The optical apparatus according to claim 4, wherein the fluorescent material is an anthraquinone fluorescent material.

10. The optical apparatus according to claim 9, wherein the anthraquinone fluorescent material is represented by the following structural formula (3):

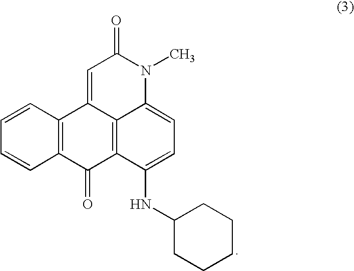

11. The optical apparatus according to claim 3, wherein the matrix polymer is at least one selected from the group consisting of polymethylmethacrylate, polyacrylic resin, polycarbonate resin, polynorbornene resin, polyvinyl alcohol resin, and cellulose resin.

12. The optical apparatus according to claim 11, wherein the matrix polymer is polymethylmethacrylate.

13. The optical apparatus according to claim 1, wherein the specific wavelength range of light absorbed by the light-emitting layer is in a range of 560 to 610 nm, and the target wavelength range of light emitted by the light-emitting layer is in a range of 610 to 700 nm.

14. The optical apparatus according to claim 1, further comprising a light guide plate,
wherein light emitted from the light source device exits to a side of the reflective polarizer through the light guide plate.

15. An image display, comprising:
an optical apparatus, and
a display panel,
the display panel including a display layer and a color filter,
the display panel and the optical apparatus being disposed so that the display layer is located between the color filter and the optical apparatus, and
light emitted from the optical apparatus passes through the display layer and then enters the color filter,
wherein the optical apparatus is an optical apparatus according to claim 1.

16. A liquid crystal display, comprising:
an optical apparatus, and
a liquid crystal panel,
the liquid crystal panel including a liquid crystal layer and a color filter,
the liquid crystal panel and the optical apparatus being disposed so that the liquid crystal layer is located between the color filter and the optical apparatus, and
light emitted from the optical apparatus passes through the liquid crystal layer and then enters the color filter,
wherein the optical apparatus is an optical apparatus according to claim 1.
